(19) United States
(12) Patent Application Publication
(10) Pub. No.: US 2009/0025857 A1
(43) Pub. Date: Jan. 29, 2009

(54) Method And Machine For Rubberizing An Annular Surface Of A Body

(75) Inventors: Giorgio Marangoni, Rovereto (IT); Sergio Fait, Rovereto (IT)

Correspondence Address: FROMMER LAWRENCE & HAUG, 745 FIFTH AVENUE- 10TH FL., NEW YORK, NY, 10151, US

(73) Assignee: MARANGONI MECCANICA S.P.A., Rovereto (IT)

(21) Appl. No.: 11/993,943

(22) PCT Filed: Jun. 26, 2006
(86) PCT No.: PCT/EP2006/063566

§ 371 Date: Jun. 26, 2008

(30) Foreign Application Priority Data
Jun. 28, 2005 (IT) TO2005A 000450

(51) Int. Cl. B29D 30/30; B29D 30/60

(52) U.S. Cl. 156/130; 156/397

(57) ABSTRACT

Method and machine for rubberizing an annular surface of a body, the rubberized coating being applied by bringing said annular surface into rotation about an axis and progressively coating the annular surface itself by means of a strip, of a determined section, of elastomeric material supplied by an extruder, shaped by at least one calender and applied, at a determined application speed, to the annular surface to be rubberized by an applicator roller having a determined peripheral speed and positioned tangential to the annular surface to be rubberized at a point of application of the strip; the rotation of the annular surface being controlled so as to maintain the application speed constant; and the section of the strip being controlled by applying to the strip a first drawing, always constant, between the applicator roller and the annular surface to be rubberized, and a further drawing upstream to the first drawing; the further being constant to apply to the annular surface a strip with a constant section, or variable in order to apply to the annular surface a strip with variable section according to a determined law.

### TECHNICAL FIELD

The present invention relates to a method and machine for rubberizing an annular surface of a body, preferably, but not necessarily, a tyre carcass, to which the following description will make specific reference, without excluding general reference.

### BACKGROUND ART

In the rubber industry, it is known to use, for rubberizing an annular surface of a tyre carcass, a rubberizing machine, in which the carcass to be rubberized is fitted onto a spindle to be brought into rotation about its axis by the thrust of a motor, and rubberizing is carried out by progressively coating the annular surface to be rubberized by means of a strip of elastomeric material, of a determined section, applied to the annular surface to be rubberized by a feeder comprising an extruder for the production of elastomeric material in the form of a normally circular section band, an applicator roller positioned tangential to the annular surface to be rubberized, and a feeding line that passes the elastomeric material from the extruder to the applicator roller. The feeding line generally comprises a plurality of components arranged in series, and at least one of these components is a calender adapted to transform the band produced by the extruder into the mentioned strip of determined section.

In the known machines of the type described above, the applicator roller and the spindle are supported in such a way as to be able to effect, with respect to each other, relative motion both parallel and orthogonal to the axis of rotation of the spindle, and about an axis orthogonal to the axis of rotation of the spindle, and the motor of the spindle is a variable speed motor.

In rubberizing an annular surface of a tyre carcass, one of the most difficult problems to solve is the control, according to a determined law, of the quantity of elastomeric material applied, at any time, to the annular surface to be rubberized.

In EP-1 230 080, in which an elastomeric material is extruded directly onto the annular surface to be rubberized, the above-mentioned problem is resolved by adjusting the application speed of the elastomeric material, that is the angular velocity of the spindle, so as to regulate the stretch given to the elastomeric material at the application point and, therefore, to regulate according to a determined law, and from one point on the annular surface to be rubberized to another, the shape and the dimensions of the section of the strip of elastomeric material that is spread onto the annular surface to be rubberized.

The solution proposed by EP-1 230 080 may in itself be problematic, since the physical characteristics of the bond created between the carcass to be rubberized and the strip of elastomeric material applied depend considerably on the stretch given to the elastomeric material at the application point, and a variation in this stretch from one point of the annular surface to be rubberized to another may cause the formation of rubber layers that are not homogeneous in their mechanical bonding to the carcass.

The above considerations also apply to U.S. Pat. No. 4,240,863, where an apparatus is disclosed for applying a strip of elastomeric material to a surface to be rubberized, the apparatus comprising a feeder in turn comprising an extruder for the production of elastomeric material in the form of a band, an applicator roller positioned tangential to the surface to be rubberized, and a feeding line that passes the elastomeric material from the extruder to the applicator roller and includes a belt conveyor. In this apparatus, a first amount of stretch is supplied by driving the belt conveyor at a controlled higher linear rate than the rate of extrusion of the band from the extruder; and a second amount of stretch may be obtained by moving the surface to be rubberized at a controlled greater rate than the rate of movement of the belt conveyor. In this way, a very precise control on the overall stretching occurring between the extruder and the applicator roller is obtained, but no control is applied to a third amount of stretching, which is always present between the applicator roller and the surface to be rubberized, and which is normally a variable amount of stretching. This third amount of stretching, which is due to irregularities in the torque transmission between the spindle and the applicator roller, has a great influence not only on the physical characteristics of the bond created between the surface to be rubberized and the strip of elastomeric material applied thereto, but also on the quantity of rubber applied to the surface to be rubberized.

### DISCLOSURE OF INVENTION

The object of the present invention is to provide a method for rubberizing an annular surface of a body, which makes it possible to control precisely, according to a determined law, the quantity of elastomeric material applied, at any time, to the annular surface to be rubberized without encountering the above-mentioned drawback stemming from variable physical characteristics of the bond created between the surface to be rubberized and the strip of elastomeric material applied thereto.

According to the present invention there is provided a method for rubberizing an annular surface of a body as set forth in the claim 1 and, preferably, as set forth in any of the subsequent claims, directly or indirectly dependent from claim 1.

According to the present invention a machine for rubberizing an annular surface of a body is also described, as set forth in claim 10 and, preferably, as set forth in any of the subsequent claims, directly or indirectly dependent from claim 10.

### BRIEF DESCRIPTION OF THE DRAWINGS

The present invention will now be described with reference to the enclosed stretches, which illustrate non-limitative embodiments thereof, in which:

FIG. 1 shows schematically and in elevational side view a first preferred embodiment of the machine according to the present invention;

FIG. 2 shows in enlarged scale a detail of FIG. 1;

FIG. 3 shows a plan view of the detail of FIG. 2; and

FIG. 4 shows schematically and in elevational side view a second preferred embodiment of the machine according to the present invention.

### BEST MODE FOR CARRYING OUT THE INVENTION

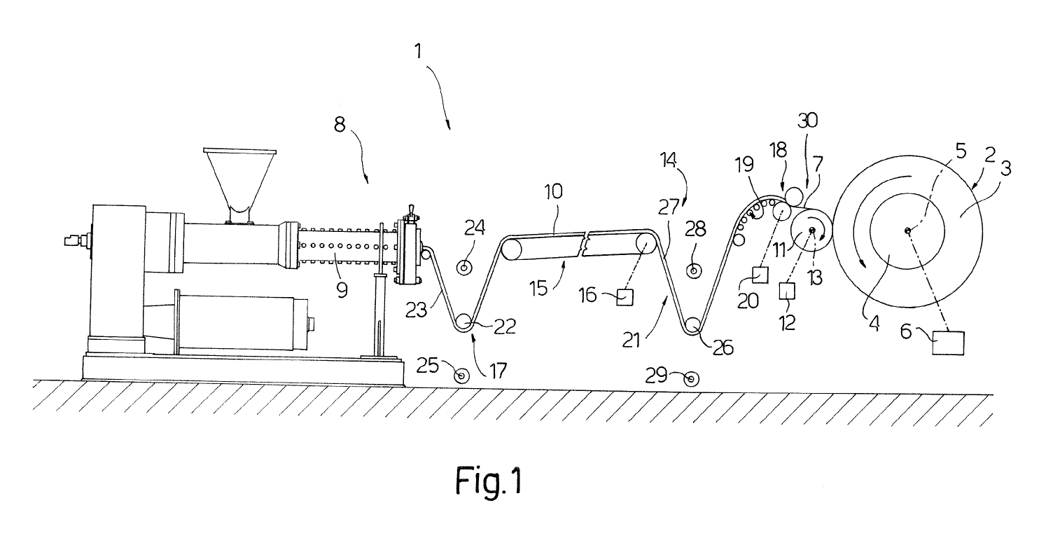

In FIG. 1, it is indicated by 1, as a whole, a machine for hot rubberizing an annular surface 2 of a body, in the case in point a toroidal body comprising a tyre carcass 3, fitted on a spindle 4 so as to be brought into rotation about an axis 5 thereof, coaxial to the annular surface 2, under the thrust of a variable speed motor 6.

The annular surface 2 is rubberized by progressively coating the annular surface 2 itself by means of a strip 7, of a predetermined section, of elastomeric material applied to the annular surface 2 by a feeder 8, being part of the machine 1 and comprising a screw extruder 9 for producing elastomeric material in the form of a band 10 normally of circular section, an applicator roller 11 arranged tangential, in use, to the annular surface 2 itself and fitted to turn, under the thrust of a drive unit 12, about an axis 13 parallel to an axis 5 and defining, with axis 5, a plane P.

The machine 1 further comprises a feeding line 14 which passes the elastomeric material from the extruder 9 to the applicator roller 11.

The feeding line 14 comprises a conveyor belt 15 which receives the band 10 and provided with a drive unit 16; a first dandy roll device 17 arranged between an outlet of the extruder 9 and an inlet of the conveyor belt 15; a calender 18, which is arranged between an outlet of the conveyor belt 15 and the applicator roller 11, is provided with an entry guide 19 and a drive unit 20 and is adapted to receive the band 10 and transform it into the strip 7; and a second dandy roll device 21 arranged between the outlet of the conveyor belt 15 and the entry guide 19.

The dandy roll device 17 is adapted to control the drive unit 16 of the conveyor 15 and comprises a dandy roll device 22 supported, in use, by band 10 at a loop 23 and mobile, following the variations in length of the loop 23, within a field defined by two sensors 24 and 25, of which the sensor 24 is arranged above the sensor 25 and at a determined distance from sensor 25.

Similarly, the dandy roll device 21 is adapted to control the speed of the screw (not illustrated) of the extruder 9 and comprises a dandy roll device 26 supported, in use, by the band 10 at a loop 27 and mobile, following the variations in length of the loop 27, within a field defined by two sensors 28 and 29, of which the sensor 28 is arranged above the sensor 29 and at a determined distance from the sensor 29.

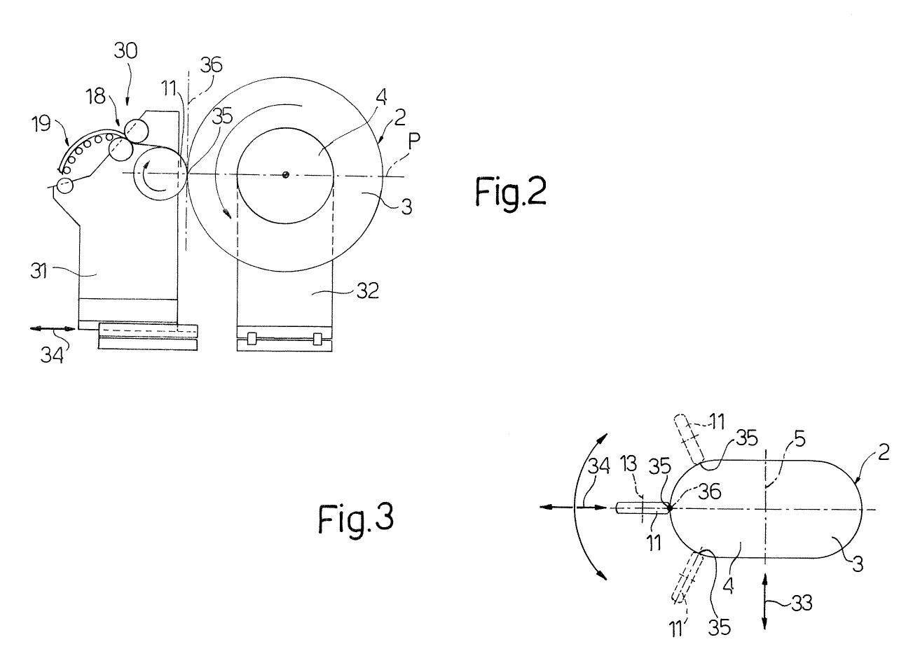

As better shown in FIGS. 2 and 3, the calender 18 defines, together with the relative entry guide 19 and the applicator roller 11, a forming machine 30 provided with a single base 31; the spindle 4 is supported by a relative base 32; and bases 31 and 32 are motorised so as to effect, with respect to each other and in a known and not illustrated manner, relative movements in a direction 33 parallel to the axes 5 and 13; relative approach movements in a direction 34 parallel to plane P and orthogonal to direction 33 from and to a contact position, in which the applicator roller 11 is arranged in contact with the annular surface 2 at an application point (or zone) 35 arranged on the plane P; and a relative rotation around an axis 36 orthogonal to the plane P.

In use, the machine 1 carries out a hot rubberizing procedure on the annular surface 2 of the carcass 3 forming, on the annular surface 2 itself, both the sidewalls (not illustrated), and the tread (not illustrated), by applying to the annular surface 2, the strip 7 normally arranged, in a known manner, with a determined inclination and on one or more layers.

In the machine 1, the applicator roller 11 is urged into contact, with a determined pressure, with the annular surface 2 at the application point 35, and the band 10 produced by the extruder 9 is fed to the conveyor belt 15 through the dandy roll device 17 and, therefore, through the dandy roll device 21 to the entry guide 19 of the calender 18, which transforms the band 10 into the strip 7 and feeds the strip 7 itself to the applicator roller 11. The strip 7 is arranged in contact with the applicator roller 11 along an arc of approximately 90°, at the end of which the strip 7 itself is transferred to the carcass 3 at the application point 35, which is moved, by relative movement of the bases 31 and 32 with respect to each other and by bringing the carcass 3 into rotation about the axis 5, such that the applicator roller 11 is allowed to brush the entire annular surface 2.

The hot rubberizing procedure described above can be controlled by two different principal control modes which both envisage constant application speed of the strip 7 on the annular surface 2 and constant stretch of the strip 7 at the application point 35.

Here it is convenient to recall that the application of constant stretch to the strip 7 at the application point 35 corresponds to both the constant bonding features of the strip 7 to the carcass 3 and to constant deformation of the section of the strip 7 when the strip 7 itself passes from the applicator roller 11 to the carcass 3.

According to a first control mode, during the start-up transient, the motor 6 is adjusted so as to give a determined value to the speed of the carcass 3 at the application point 35; subsequently motor 6 is adjusted such that it will maintain this speed, constantly equal to the mentioned determined value at the application point 35. Since the distance of the application point 35 from the axis 5 varies during the rubberizing of the annular surface 2, the adjustment of motor 6 is such that the spindle 4 is given a variable angular speed inversely proportionally to the distance of the application point 35 from the axis 5.

The drive unit 12 of the applicator roller 11 is a slave to the motor 6 so as to give the applicator roller 11 itself a peripheral speed at most equal to the application speed, but preferably less than the application speed by a determined constant value. For this purpose, the drive unit 12 is composed of a transmission (not illustrated) arranged between the motor 6 and the applicator roller 11 and capable of establishing, between the speed of the application point 35 and the peripheral speed of the applicator roller 11, a differential with constant value and, therefore, capable of applying constant stretch to the strip 7 when the strip 7 itself passes from the applicator roller 11 to the annular surface 2; or the drive unit 12 is composed of a slave motor (not illustrated) served by the motor 6 to maintain the afore-mentioned constant value of differential speed between the applicator roller 11 and the carcass 3.

Similarly, the drive unit 20 of the calender 18 is a slave to the motor 6 so as to give the calender 18 itself a normally constant speed and at most equal to the application speed. In the machine 1, the speed of the calender 18 is preferably maintained lower than a first determined value which in normal operating conditions is a constant value, and than a second value, which in normal operating conditions is a determined constant value, lower than the former, at the peripheral speed of the applicator roller 11. In this way, a further speed differential, normally of constant value, is established between the feed speed of the strip 7 through the calender 18 and the peripheral speed of the applicator roller 11, corresponding to the application of said strip 7, of a further stretch, normally constant between the calender 18 and the applicator roller 11.

The above description shows that, using the machine 1, it is possible to apply two stretches in series to the strip 7, of which the latter, applied between the applicator roller 11 and the application point 35, is strictly constant. If the further stretch, applied to the strip 7 upstream of the applicator roller 11, is maintained constant, the strip 7 applied to the annular surface 2 is a strip of strictly constant section.

In the case of particular requirements, where variations should be given, according to a determined law and from one point to another of the annular surface 2, to the section of the applied strip 7, it will be sufficient to adjust, according to a determined law, the drive unit 20 so as to apply to the strip 7 a variable stretch upstream of the applicator roller 11.

According to a further control mode, the dandy roll device 17 controls the speed of the screw (not illustrated) on the extruder 9, the dandy roll device 21 controls the speed of the motor 6 and, during the start-up transient, the extruder 9 is adjusted such that a determined value will be given to the output speed of the band 10; the speed of the conveyor belt 15 and the spindle 4 are adjusted so as to maintain the dandy roll devices 22 and 26 within central portions of the respective strokes, while the speed of the calender 18 and the applicator roller 11 are dependent, as in the previous case, on the speed of the spindle 4 which, as in the previous case, is adjusted so as to maintain constant application speed. In this case, too, since the distance of the application point 35 from the axis 5 varies during the rubberizing of the annular surface 2, the motor 6 is adjusted such that the spindle 4 is given a variable angular speed inversely proportionally to the distance of the application point 35 to the axis 5.

In a similar manner to when the machine is adjusted according to the first control mode described above, it is also possible in this case to apply to the strip 7 two stretches in series, of which the latter, applied to the strip 7 between the applicator roller 11 and the application point 35, is strictly constant. If the further stretch, applied to the strip 7 upstream of the applicator roller 11, is maintained constant, the strip 7 applied to the annular surface 2 is a strip with a strictly constant section. On the contrary, if, for particular requirements, variations should be given, according to a determined law and from one point to another of the annular surface, to the section of the strip 7 applied, it is sufficient to adjust, according to a determined law, the drive unit 20 so as to apply to the strip 7 a variable stretch upstream of the applicator roller 11.

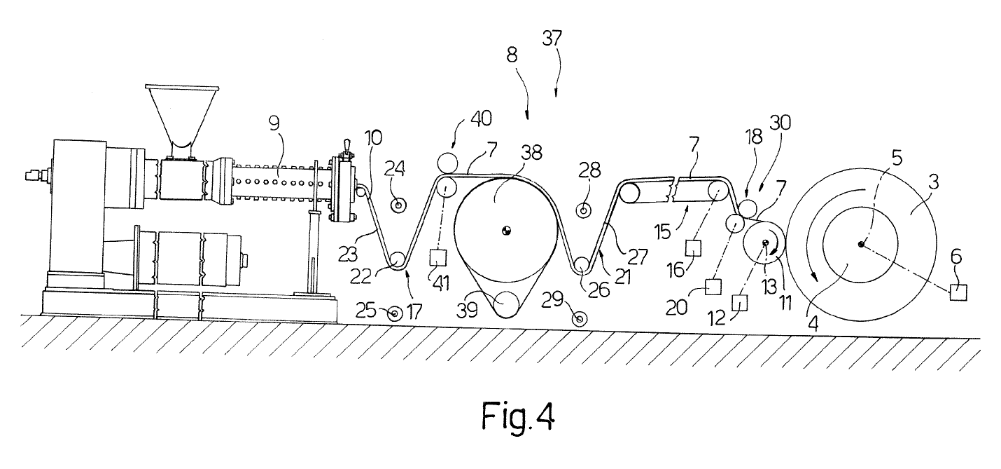

The embodiment illustrated in FIG. 4 relates to a machine 37 for cold rubberizing an annular surface 2 of a toroidal body, in the case in point, a tyre carcass 3.

The machine 37 is substantially similar to the machine 1, from which it differs in that, in the machine 37, the conveyor belt 15 is arranged downstream of the dandy roll device 21 and in the place of the entry guide 19 of the calender 18 used in the machine 1, and the drive unit 16 is a slave to the drive unit 20 of the calender 18 and is normally composed of a geared transmission (not illustrated) adapted to give the conveyor belt 15 a feed speed at most equal to, but normally slightly lower than, that of the calender 18, which, in the case of the machine 37, is not a real forming calender as in the case of the machine 1, but simply a finishing calender.

The machine 37 also differs from machine 1 because it comprises a cooling roller 38 arranged between the dandy roll devices 17 and 21 and brought into rotation by a drive unit 39, and a forming calender 40 similar to the calender 18 on machine 1 and arranged between the cooling roller 38 and the dandy roll device 17. The forming calender 40 is driven by a drive unit 41 slave to the drive unit 39 and normally composed of a geared transmission (not illustrated) adapted to give the forming calender 40 a feed speed at most equal to, but normally slightly lower than, the peripheral speed of the cooling roller 38.

In the machine 37, the dandy roll device 21 plays the simple role of mechanical accumulator and it does not perform any control function, while the dandy roll device 17 controls the screw speed of the extruder 9.

The cold rubberizing procedure carried out by the machine 37 is normally controlled in a similar manner to the first control modes of the hot rubberizing procedure carried out by machine 1 and allows, if desired, to apply to the elastomeric material, and in particular to the strip 7 (which in the case of the machine 37 is formed by the forming calender 40 and only subsequently perfected by the finishing calender 18), a first controlled stretch during the passage of the strip 7 from the forming calender 40 to the cooling roller 38; a second controlled stretch during the passage of said strip 7 from the conveyor belt 15 to the finishing calender 18; a third controlled stretch during the passage of the strip 7 from the finishing calender 18 to the applicator roller 11; and a final, always rigorously constant, stretch during the passage of the strip 7 from the applicator roller to the carcass 3.

Similarly as described for the machine 1, the mentioned first, second and third stretches applicable to the strip 7 in the machine 37 may be, as usually happens, constant, and in this case the dimensions and the shape of the section of the strip 7 applied to the annular surface 2 remain rigorously constant and determined by the intensity of these stretches and of the last stretch, or at least one of the mentioned three first stretches is varied according to a determined law so as to deposit on the annular surface 2 a strip 7 of variable section according to a determined law.

Obviously, in both machine 1 and machine 37, each of the stretches applicable to strip 7 before the last constant stretch applied between the applicator roller 11 and the carcass 3 may be equal to zero.

In conclusion, given the above description it is clear that in machines 1 and 37:
by applying a constant controlled stretch to strip 7 between the applicator roller 11 and the carcass 3 it is possible to rubberize the carcass 3 itself along the annular surface 2 in a largely homogeneous manner from the view-point of the bonding of the elastomeric material to the annular surface 2 itself;
by applying one or more controlled stretches to the strip 7 upstream of the applicator roller 11 it is possible to give the strip 7 itself determined transverse dimensions;
if all the controlled stretches applied to the strip 7 upstream of the applicator roller are constant, the strip 7 which is applied to the annular surface 2 presents a section that remains rigorously constant, and the annular surface 2 is rubberized in a largely homogeneous manner from view-point of the bonding of the elastomeric material to the annular surface 2 itself;
if at least one of the controlled stretches applied to the strip 7 upstream of the applicator roller 11 is a variable stretch according to a determined law, the strip 7 that is applied to the annular surface 2 presents a section that varies according to a determined law, while the annular surface 2 is always rubberized, even in this case, in a largely homogeneous manner from the view-point of the bonding of the elastomeric material to the annular surface 2 itself.

1. A method for rubberizing an annular surface of a body, the rubberizing being carried out by bringing the annular surface into rotation about an axis; by progressively coating the annular surface itself by means of a strip, of determined section, of elastomeric material, produced by an extruder, controlled in section by at least one calender and fed, at a given application speed, onto the annular surface to be rubberized by an applicator roller having a peripheral speed and arranged tangential to the annular surface to be rubberized in an application point of the strip; and by controlling the section of the strip;
wherein:
the section of the strip is further controlled by positively controlling both the application speed and the peripheral speed so as to apply to the strip a first drawing, always constant, between the applicator roller and the annular surface to be rubberized; and by applying at least a further drawing upstream of the first drawing.

2. A method according to claim 1, in which the further drawing is constant so as to give the strip a determined constant section.

3. A method according to claim 1, in which the further drawing is variable to give the strip a variable section according to a determined law.

4. A method according to claim 1, in which the elastomeric material is fed by a feeding line, which feeds the elastomeric material from the extruder to the applicator roller through a plurality of components arranged in series, at least one of which is composed of said calender for transforming a band of elastomeric material produced by the extruder into the strip of determined section; at least one component of the feeding line being actuated so as to give the elastomeric material the further drawing upstream of the first drawing.

5. A method according to claim 1, and comprising the steps of fitting the body onto a spindle with the annular surface in a coaxial position to an axis of the spindle; bringing the spindle into rotation about the axis so as to give the annular surface, at the application point, a determinated application speed; and reciprocally moving the applicator roller and the spindle to bring the application point to brushing, with said application speed, the entire annular surface, the spindle being powered at variable angular speed so as to maintain the application speed always equal to determined constant value; and the applicator roller being slave to the spindle so as to present a constant peripheral speed and to maintain equal to a determined constant value a speed differential existing between the application speed and the peripheral speed so as to apply to the strip said first constant drawing in the passage between the applicator roller and the annular surface.

6. A method according to claim 1, in which the annular surface is hot rubberized; the elastomeric material produced by the extruder being shaped, to obtain said strip, using only one said calender arranged immediately upstream of the applicator roller, and said further drawing being applied on the passage of the strip between the calender and the applicator roller.

7. A method according to claim 1, in which the annular surface is cold rubberized; the elastomeric material produced by the extruder being cooled by a cooling means arranged upstream of the applicator roller and being shaped, to obtain said strip, by means of one said calender arranged immediately upstream of the cooling means; one said further drawing being applied during the passage of the strip between said calender and the cooling means.

8. A method according to claim 7, in which said strip is further shaped by a further calender arranged immediately upstream the applicator roller; a said further drawing being applied during the passage of the strip between said further calender and the applicator roller.

9. A method according to claim 7, in which said strip is further shaped by a further calender arranged immediately upstream of the applicator roller, and is fed to said further calender by a conveyor belt; one said further drawing being applied during the passage of the strip between the conveyor belt and said further calender.

10. A machine for rubberizing an annular surface of a body, the machine comprising a spindle presenting an axis and adapted to support the body with the annular surface to be rubberized coaxial to the axis; first drive means to bring the spindle into rotation about the axis; and a feeding unit adapted to feed onto the annular surface a strip of elastomeric material presenting a section of determinated shape; the feeding unit comprising an extruder for the production of elastomeric material in the form of a band, a calender for transforming the band of elastomeric material produced by the extruder into the strip of determined section, an applicator roller arranged downstream from the calender, having, in use, a peripheral speed and arranged, in use, tangential to the annular surface to be rubberized at an application point of the strip to the annular surface itself and mobile relative to the spindle to bring the application point to brushing, with a determined application speed equal to the speed of the application point about the axis, the whole annular surface in conjunction with a rotation of the spindle about the axis itself; the machine being wherein the applicator roller is slaved to the spindle so as to maintain equal to a determined constant value the speed differential existing between the application speed and the peripheral speed to apply to the strip a first constant drawing during the passage between the applicator roller and the annular surface; and in that the feeding unit is shaped so as to apply to the strip a further drawing upstream of the first drawing.

11. A machine according to claim 10, in which the feeding unit comprises a feeding line of the elastomeric material from the extruder to the applicator roller, and the feeding line comprises a plurality of components arranged in series, at least one of which is said calender for transforming the band of elastomeric material produced by the extruder into the strip of determined section; at least one component of the feeding line being a motorised component provided with further driving means to give the elastomeric material a further drawing upstream of the first drawing.

12. A machine according to claim 11, in which the further driving means are adjusted such that said further drawing results in a constant value.

13. A machine according to claim 12, in which the further driving means is adjusted such that said further drawing results in a variable value according to a determined law.

14. A machine according to claim 11, in which the feeding line comprises a conveyer belt and a first and second dandy roll devices, arranged between the extruder and the conveyor belt and, respectively, between the conveyor belt and the calender; the calender being said motorised component.

15. A machine according to claim 14, in which the first dandy roll device controls the conveyor belt, while the second dandy roll device controls the peripheral speed of the spindle.

16. A machine according to claim 14, in which the first dandy roll device controls the conveyor belt, while the second dandy roll device controls the extruder.

17. A machine according to claim 11, in which the feeding line comprises a calender, a cooling roller arranged downstream of the calender and a first and second dandy roll devices arranged between the extruder and the calender and, respectively, downstream of the cooling roller; the calender being said motorised component.

18. A machine according to claim 17, in which the feeding line comprises a first calender; a cooling roller arranged downstream of the first calender; a conveyor belt; a second calender; and a first and second dandy roll devices arranged between the extruder and the first calender and, respectively, between the cooling roller and the conveyor belt; at least one of said first and second calenders and the conveyor belt being one said motorised element.

19. A machine according to claim 17, in which the first dandy roll device controls the extruder, while the second dandy roll device is simply a mechanical compensator.
